(19) United States
(12) Patent Application Publication
(10) Pub. No.: US 2025/0369656 A1
(43) Pub. Date: Dec. 4, 2025

(54) DRILLING LAYOUT FORMED IN A SUBSOIL FOR A GEOTHERMAL INSTALLATION, INSTALLATION AND ASSOCIATED METHOD

(71) Applicant: DYNASTEER, COSNE-COURS-SURLOIRE CEDEX (FR)

(72) Inventors: François Guy Jacques René MILLET, ANTONY (FR); Albert Louis BENOIT, SAINT-PERE-SUR-LOIRE (FR)

(21) Appl. No.: 18/878,043

(22) PCT Filed: Jun. 23, 2023
(86) PCT No.: PCT/EP2023/067149

§ 371 Date: Dec. 22, 2024

(30) Foreign Application Priority Data
Jun. 24, 2022 (FR) 2206306

(51) Int. Cl. F24T 10/10; E21B 43/30; F24T 10/00

(52) U.S. Cl. CPC F24T 10/10; E21B 43/305; F24T 2010/53

(57) ABSTRACT

This layout includes at least one heat exchange unit including at least one central well extending from the surface of the subsoil, at least one flank well extending from the surface of the subsoil and having an inclined lateral portion, at least two separate drains connecting the central well and the inclined lateral portion of the flank well. For the or each heat exchange unit, the central well, the flank well and each drain are set out in the one same vertical plane, the intersections between the drains and the central well and between the drains and the inclined lateral portion being separated from one another and the drains opening inclined by an angle less than 45° with respect to the inclined lateral portion.

### CROSS-REFERENCE TO RELATED APPLICATIONS

This application claims benefit under 35 USC § 371 of PCT Application No. PCT/EP2023/067149 entitled DRILLING LAYOUT FORMED IN A SUBSOIL FOR A GEOTHERMAL INSTALLATION, INSTALLATION AND ASSOCIATED METHOD, filed on Jun. 23, 2023 by inventors François Guy Jacques Rene Millet and Albert Louis Benoit. PCT Application No. PCT/EP2023/067149 claims priority of French Patent Application No. 22 06306, filed on Jun. 24, 2022.

### FIELD OF THE INVENTION

The present invention relates to a drilling layout formed in a subsoil for a geothermal installation, comprising at least one heat exchange unit comprising:
at least one central well extending from the surface of the subsoil
at least one flank well extending from the surface of the subsoil and having an inclined lateral portion;
at least two separate drains connecting the central well and the inclined lateral portion of the flank well;

[symbol]

Such a layout is intended for use in particular as a closed-loop heat exchanger within a non-intrusive geothermal installation.

Such a layout does not require an underground site producing a hot geothermal fluid, for example from an aquifer. It has the advantage of being able to be installed in a variety of sites, and relies solely on the thermal gradient rather than extracting a fluid from the subsoil.

Such a layout is configured for the circulation of a heat transfer fluid in a defined loop through one of the inclined wells or vertical wells, then through drains drilled deep into the ground, and finally back into the other of the inclined wells or vertical wells. As it circulates, particularly in the drains, the heat transfer fluid stores thermal energy from the subsoil, mainly from the radioactivity of the earth's crust. The warmed heat transfer fluid brought to the surface feeds a recovery installation for the distribution of thermal energy, and/or the conversion of recovered thermal energy into electrical energy. The heat transfer fluid can also transmit thermal energy to the subsoil to cool it.

### BACKGROUND OF THE INVENTION

WO 2020/197511 describes a layout of the aforementioned type comprising a plurality of drains with an inclined well and a vertical well. The drains converge at a single point (called a divider or manifold as described in EP 3 762663) and make it possible to limit the number of holes to be drilled and to balance head losses in the drains, while at the same time having a large underground heat exchange surface. In their non-convergent zone, the drains are distributed with a certain spatial distance between each drain to maximise heat exchange through each drain by ensuring that they do not interfere with each other.

However, such a layout is not wholly satisfactory. Drilling at the angles and with the arrangements as described above is difficult and very costly. For example, the connections between the inclined shaft and the drains require the use of elbows that could damage the drilling tools or even render them inoperative. The presence of a single point of convergence between the drains and the vertical well requires very high drilling accuracy, which can lead to drilling being slowed down and/or non-convergent drains being eliminated.

### SUMMARY OF THE DESCRIPTION

One aim of the invention is therefore to obtain a drilling layout that enables efficient heat exchange between a heat transfer fluid and the subsoil in which it is located, while offering simplified drilling trajectories that are economical to produce and maintain.

To this end, the invention relates to a drilling layout of the aforementioned type, for the or each heat exchange unit, the central well, the flank well and each drain are set out in the one same vertical plane, the intersections between the drains and the central well and between the drains and the inclined lateral portion being separated from one another and the drains opening inclined by an angle less than 45° with respect to the inclined lateral portion

The drilling layout according to the invention may comprise one or more of the following features, taken alone or in any combination that is technically possible:
the central well is vertical;
the central well has at least one upper vertical portion located above the drains, the upper vertical portion having a diameter greater than the diameter of each drain;
the flank well and the central well each have at least one upper vertical portion;.
the flank well comprises at least one upper vertical portion, at least one slightly inclined portion connected to the upper vertical portion by a curved portion, the inclined lateral portion extending the slightly inclined portion downwards;
the drains are drilled in a plutonic rock, in particular granite, or in a metamorphic rock, in particular gneiss;
the heat exchange unit comprises at least one sedimentation leg terminating at least one of the central well and the inclined lateral portion;
the angle formed by the local axis of the central well oriented downwards at the central intersection and the local axis of the drain, taken at the lateral intersection, oriented away from the central well, is strictly less than 90° and is in particular between 45° and 70°;
the heat exchange unit comprises drains each comprising a linear portion spaced apart vertically by a maximum of 200 metres, the linear portions advantageously being parallel to each other; and
the surface distance between the central well and the flank well within the same heat exchange unit is between 20 m and 100 m.
the angle formed by the local axis of the straight vertical portion of the flank well pointing downwards and the local axis of the inclined lateral portion pointing downwards, taken at the intersection between these two axes, is an acute angle, the flank well being concave.

The invention also relates to a geothermal installation comprising a drilling layout as defined above, a system for pumping heat transfer fluid to be heated or cooled into either the central well or the flank well, a system for recovering heated or cooled heat transfer fluid from the other of the central well and the flank well and a device for distributing and/or converting energy from the heat transfer fluid.

The invention also relates to a method for manufacturing a drilling layout in a subsoil, comprising the following steps:
drilling the flank well comprising an inclined lateral portion from the surface of the subsoil;
drilling the central well from the subsoil surface;
drilling at least two separate drains connecting the central well and the inclined lateral portion of the flank well;

[symbol]

For the or each heat exchange unit, the central well, the flank well and each drain are drilled in the one same vertical plane, the central intersections between the drains and the central well and between the drains and the inclined lateral portion being separated from one another and the drains opening inclined by an angle less than 45° with respect to the inclined lateral portion.

The drilling method according to the invention may comprise one or more of the following features, taken alone or in any combination that is technically possible:
the drilling of the flank well comprises injecting drilling fluid through a drilling tool and returning the drilling fluid through the flank well in the annulus defined between the drilling tool and a wall of the flank well; the drilling of the central well from the surface and of at least a first drain being carried out after the drilling of the flank well, keeping the drilling fluid under pressure in the flank well at least during the formation of the lateral intersection between the first drain and the inclined lateral portion, the drilling fluid under pressure in the inclined lateral portion rising through the first drain towards the central well after the lateral intersection is formed; and
the drilling of at least two separate drains comprises drilling a second drain above the first drain, after the drilling of the first drain, pressurised drilling fluid being kept in circulation in the flank well and through the first drain at least while the lateral intersection between the second drain and the inclined lateral portion is formed, the pressurised drilling fluid in the inclined lateral portion rising through the second drain towards the central well after the lateral intersection has been formed;
the drilling tool (commonly known as a “drill string”) comprises a drill bit, a rotating drill string and a rotating rod assembly between the drill bit and the rod assembly capable of altering the angular orientation of the drill bit relative to the rod assembly.

### BRIEF DESCRIPTION OF THE DRAWINGS

The invention will be better understood upon reading the following description, given only as an example, and with reference to the attached drawings, in which:

FIG. 1 is a schematic cross-section along a vertical median plane of a geothermal drilling installation fitted with a heat exchange unit;

FIG. 2 is a schematic cross-section along a vertical median plane illustrating a drilling method for the heat exchange unit shown in FIG. 1;

FIG. 3 is a schematic cross-section along a vertical median plane of a variant geothermal drilling installation fitted with a two heat exchange units that are coplanar;

FIG. 4 is a schematic cross-section along a vertical median plane of another geothermal drilling installation with two heat exchange units arranged at 180° and sharing a well; and

FIG. 5 is a schematic cross-section along a vertical median plane of a drilling layout initially designed to exploit an aquifer and capable of being transformed into a drilling layout according to the invention if the aquifer cannot be exploited or even does not exist.

### DETAILED DESCRIPTION OF EMBODIMENTS

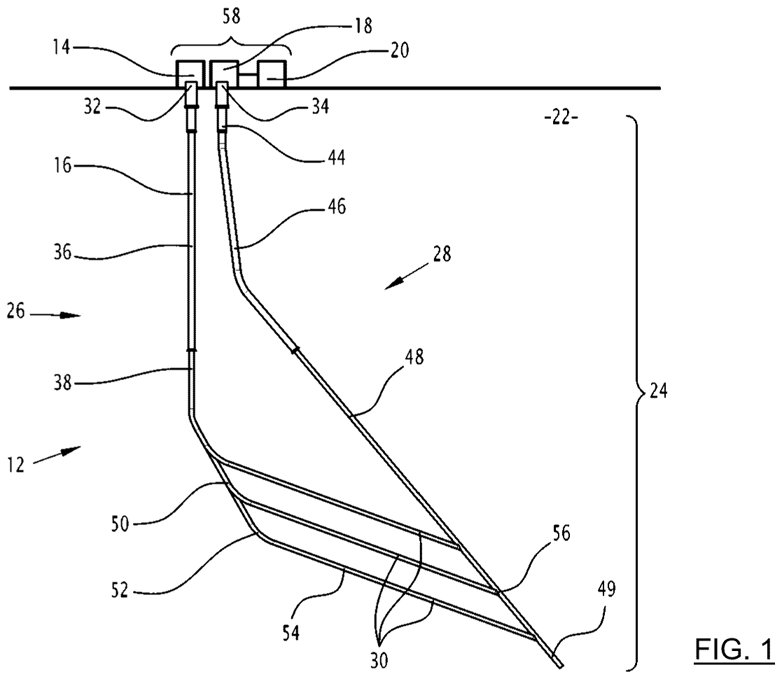

A first geothermal installation 10 for producing heat according to the invention is shown schematically in FIG. 1.

The installation 10 comprises a drilling layout 12 according to the invention, a system 14 for pumping heat transfer fluid 16 into the drilling layout 12, a system for recovering 18 of the heat transfer fluid 16 heated from the drilling layout 12 and a device for distributing and/or converting energy 20 from the heated heat transfer fluid 16.

The drilling layout 12 is cut into a subsoil 22 through subsoil formations 22. It comprises at least one heat exchange unit 24 located in a plane. The heat exchange unit 24 comprises at least one central well 26, at least one flank well 28 and at least two drains 30 connecting the central well 26 to the flank well 28, the wells 26, 28 and drains 30 being coplanar.

The heat exchange unit 24 is a set of underground pipes through which the same heat transfer fluid 16 flows, supplied by the pumping system 14 and recovered by the recovery system 18. The heat from the heat transfer fluid 16 recovered by the recovery system 18 is used by the energy distribution and/or conversion device 20, for example to generate steam to drive a turbine.

The central well 26 and the flank well 28 open onto the surface. These wells 26, 28 are controlled at subsoil surface by wellheads 32, 34.

The central well 26 has an upper vertical portion 36 starting from the surface and penetrating vertically into the subsoil 22, and a lower vertical or inclined portion 38 located in the lower extension of the upper vertical portion 36.

The upper vertical portion 36 has an inner diameter greater than the inner diameter of the lower portion 38. Advantageously, it has a casing cemented to the formation (in particular a thermally insulating casing if the hot heat transfer fluid is brought up through this well).

The depth of the central well 26 is advantageously between 200 metres and 5000 metres in order to reach a metamorphic or plutonic rock capable of withstanding continuous erosion from the heat transfer fluid for at least 50 years.

In this example, the flank well 28 comprises a straight vertical portion 44, opening at the level of the surface of the subsoil 22, a slightly inclined portion 46 (to avoid any risk of interference with the upper vertical portion 36 of the central well 26), connected to the straight vertical portion 44 by a curve, and an inclined lateral portion 48 which extends the slightly inclined portion 46 downwards. The flank well 28 also defines a sedimentation leg 49 which terminates the inclined lateral portion 48 at the bottom.

The angle defined by the local axis of the straight vertical portion 44 pointing downwards and the local axis of the shallow inclined portion 46 also pointing downwards is advantageously between 2 and 10°.

The angle defined by the local axis of the straight vertical portion 44 pointing downwards and by the local axis of the inclined lateral portion 48 also pointing downwards is advantageously between 30° and 50°. This provides a heat exchange unit with a large exchange surface while limiting the inclination of the portions and the lateral extent of the drilling layout 12, for ease of construction and maintenance.

The drains 30 are drilled from the central well 26 and connect it to the flank well 28. Each drain 30 has a central intersection 50 with the lower portion 38 of the central well 26, an angled portion 52, a linear portion 54, and a lateral intersection 56 with the inclined lateral portion 48 of the flank well 28.

The central intersection 50 with the lower portion 38 of the central well 26 is positioned in the vertical plane of the heat exchange unit 24 and connects the lower portion 38 of the central well 26 to the angled portion 52.

The angled portion 52 is extended by the linear portion 54. The linear portion defines the preferred location for heat exchange between the heat transfer fluid 16 and the formation. The linear portion 54 opens into the flank well 28 at the lateral intersection 56.

The angled portions 52 of the drains 30 have a radius of curvature such that the angle formed by the local axis of the central well 26, oriented downwards at the central intersection 50, and the local axis of the drain 30, taken at the lateral intersection 56, oriented away from the central well 26, is strictly less than 90° and is in particular between 45° and 70°.

The linear portion 54 is delimited externally by a non-adiabatic rock that allows a flow of heat to pass between the subsoil 22 and the heat transfer fluid 16 present in the linear portion 54 of the drain 30. The formation through which the latter passes is, for example, a metamorphic rock, such as gneiss, or a plutonic rock, such as granite. The linear portion 54 has no casing to maximise heat exchange between the formation and the heat transfer fluid 16 and reduce the time, cost and risks involved in building the heat exchange unit 24.

The linear portions 54 of the drains 30 are drilled parallel one above the other in the vertical plane of the heat exchange unit.

The distance separating the linear portions 54 in a direction orthogonal to the linear portions 54 is, for example, between 50 m and 500 m, in particular between 80 m and 200 m.

The linear portion 54 ends at the lateral intersection 56 with the inclined lateral portion 48 located above the sedimentation leg 49.

The intersections of the drains 30 with the central well 26 and with the inclined lateral portion 48 are separate from each other. The drains 30 opening into the flank well 28 are inclined at an angle of less than 45° to the inclined lateral portion 48 at the lateral intersection 56, for example at an angle of between 15° and 35°.

The sedimentation leg 49 is designed to receive any drilling or tool debris introduced into the flank well 28 or into the drains 30, without obstructing the portions 30, 36, 38, 44, 46, 48, 50, 52, 54 and 56.

The surface assembly 58 of the installation 10 houses the pumping system 14, the recovery system 18, and the energy distribution and/or conversion device 20. The surface assembly 58 is positioned on the surface of the subsoil 22 and houses the heads of the wells 32 and 34.

The surface distance between the head 32 of the central well 26 and the head 34 of the flank well 28 within the same heat exchange unit is advantageously between 20 m and 100 m.

The heat transfer fluid 16 pumping system 14 is connected to the wellhead 32 of the injector well, which is either the central well 26 or the flank well 28 depending on the desired direction of flow in the drilling layout 12. The pumping system 14 pumps a heat transfer fluid 16 into the injector well at a pressure adapted to the fluid's proper flow within the drilling layout 12.

The heat transfer fluid 16 is based, for example, on water or another liquid such as an alcohol, an oil or a refrigerant, or even CO2. The heat transfer fluid or gas circulates in a closed loop, which may be pressurised.

The recovery system 18 for the heat transfer fluid 16 is connected to the head of the production well formed by the other of the central well 26 or the flank well 28. The recovery system 18 recovers the heated heat transfer fluid 16 and returns it to the energy distribution and/or conversion device 20. In the case of conversion to electricity, the energy conversion device 20 comprises, for example, a turbine for expanding steam produced from the heated heat transfer fluid 16, an electricity generator, and a condenser for cooling the heat transfer fluid 16.

In the case of energy distribution, the heat transfer fluid is used directly or in heat exchange with a fluid to heat, for example, homes, factories, industrial processes, greenhouses, hotels, swimming pools, recreation centres, etc.

In another embodiment, the heat transfer fluid can also be used to cool them, as well as the water in thermal power stations (coal, oil, gas and nuclear), in order to reduce consumption by replacing cooling towers.

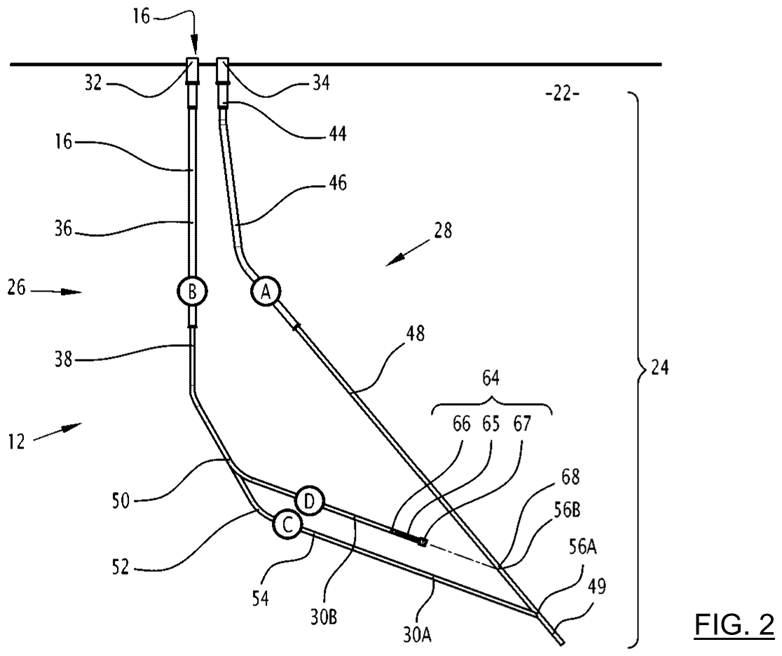

A method for constructing the drilling layout 12 will now be described, with reference to FIG. 2. This method is implemented with a surface installation comprising a directed drilling tool 64 fitted with a swivel system 65, means for rotating the directed drilling tool 64, advantageously at the bottom as well as at the surface, and means for injecting a drilling fluid into the drilling tool 64 (not shown).

The drilling tool 64 (or “drill string”) comprises a hollow rod assembly 66 placed in the well to be drilled, a drill bit 67, and a swivel system 65 supporting the drill bit 67.

The swivel system 65 can continuously measure the inclination, azimuth, and sludge pressure around the drilling tool 64. It is also able to communicate with surface equipment and to detect and be guided by an active beacon 68 placed in the inclined lateral portion 48 of the flank well 28.

The drill bit 67 comprises rock-destroying tools and is advantageously rotated relative to the rod assembly 66 about the axis of the rod assembly 66 by means of a downhole motor.

Rock-destroying tools use, for example, a polycrystalline diamond compact (PDC) or tricone bit, a percussion system, and/or pulsed high pressure (PHP), plasma or millimetre electromagnetic wave drilling to drill metamorphic and plutonic rocks.

The rod assembly 66 is removably screwed on top of the rotary swivel system 65. It is made up of a number of hollow rods screwed together vertically as the well drilling progresses. The rod assembly 66 defines an internal circulation duct for the drilling fluid.

The rotary swivel system 65 defines a controlled joint between a main body and a swivel housing to control the direction of drilling in real time. An example of a rotary swivel system 65 is described in WO2007/110502A1.

The drilling fluid is advantageously based on water and bentonites, additivated if necessary to reduce investment and pollution risks.

In a first phase marked A in FIG. 2, the drilling of the layout 12 begins, for example, with the creation of the flank well 28 from the surface.

The straight vertical portion 44, the slightly inclined portion 46 and the inclined lateral portion 48 are drilled successively, the drilling tool 64 gradually becoming inclined thanks to the rotary swivel system 65.

A drilling fluid is introduced at the surface and circulates through the inner pipe of the rod assembly 66 to the drill bit 67. When it emerges from the drill bit 67, the fluid lubricates and cools it.

The drilling fluid then rises through the annular space defined between the drilling tool 64 or the rod assembly 66 and the formation defined by the wall of the flank well 28, cleaning the well and maintaining its walls.

The drilling of the flank well 28 ends with the creation of the sedimentation leg 49 at the bottom of the flank well 28 to be able to manage the potential waste created during subsequent operations. The drilling tool 64 is withdrawn from the flank well 28 by its wellhead 34.

Then, in a second phase represented by the letter B in FIG. 2, the central well 26 is drilled starting with the upper vertical portion 36 with the drilling fluid returning into the annular space defined between the drilling tool 64 and the formation defined by the wall of the central well 26.

Prior to a third drilling phase C, an active beacon 68 is placed in the well 28 at the lateral intersection point 56A to guide the tool 65 to the said point 56A with the possible help of software guidance on the surface. A pressure sensor is associated with the active beacon 68 to continuously measure the pressure at the lateral intersection point 56A. The active beacon 68 and the probe are lowered using an electric cable or, advantageously, a coiled tubing fitted with an electric cable to supply power to the active beacon 68 and the probe and to enable real-time communication with the surface.

In the third phase, represented by the letter C in FIG. 2, the lower portion 38, the central intersection 50, the angled portion 52 and the deepest drain 30A are then drilled down to the lateral intersection 56A with the flank well 28, reducing the drilling diameter following the installation of the production casing in the upper vertical portion 36 of the central well 26. The drilling fluid, loaded with drilling cuttings, is also returned via the annular space around the drilling tool 64 or the rod assembly 66.

Throughout phase C of drilling the drain 30A, drilling fluid is advantageously injected with coiled tubing into the flank well 28 to maintain it at a pressure at least equal to that of the drilling fluid for the drain 30A. When the lateral intersection 56A between the flank well 28 and the drain 30A is formed, an overpressure is maintained with respect to the drain 30A which has just been drilled.

In a fourth phase represented by the letter D in FIG. 2, the drain 30B is drilled. The central intersection 50 between the lower portion 38 and the first drain 30A has already been created and the drilling tool 64 branches off using the rotary swivelling system 65 to drill the drain 30B.

At the same time, the active beacon 68 and the pressure sensor are raised to the next intersection point 56B.

The drilling fluid is thus returned through the annular space around the drilling tool 64 in the portions 52, 54 of the drain 30B and then in the central well 26 to the surface, even when the lateral intersection 56B is provided.

The overpressure maintained at the lateral intersection 56B when it is drilled ensures that the drilling fluid returns to the annulus around the drilling tool 64 and prevents drilling debris from spilling into the flank well 28 and/or the drain 30A and clogging them.

The pressure of the drilling fluid in the flank well 28 is maintained by injecting drilling fluid into the flank well 28 and allowing it to circulate through the previously drilled drain(s) 30A and up through the vertical well 26.

The return of drilling fluid into the annular space of the drilling tool 64 or the rod assembly 66 in the central well 26 is the combination of the flow of drilling fluid from the flank well and the flow of drilling fluid from the drilling of the new drain 30B. As the diameter of the upper vertical portion 36 is greater than the diameter of the lower vertical portion 38 and in particular the diameter of each drain, the cumulative flow of drilling fluids from different drains 30A, 30B is thus made possible.

Each subsequent drain 30 is then drilled in the same way, identical to the phase represented by the letter D in FIG. 2. To do this, the drilling tool 64 retracts into the lower portion 38 of the central well 26 and starts drilling above the central intersection 50 between the previous drain 30 and the central well 26. The drains are drilled successively, starting with the deepest and working upwards.

At the same time, the active beacon 68 and the pressure sensor are raised to the next intersection point 56.

Once all the drains 30A, 30B have been drilled and the drilling tool 64 has been removed from the drilling layout 12, the drilling layout 12 is cleaned by injecting a fluid through one of the wellheads 32, 34 to ensure that there are no residues blocking one of the wells 26, 28 or one of the drains 30.

The cleaning fluid will advantageously be the drilling fluid filtered progressively at the surface, so that the environmental impact is minimal.

The use of geothermal plant 10 for heat production will now be briefly described.

The heat transfer fluid 16 is injected by the pumping system 14 into the drilling layout 12 via one of the wellheads 32, 34. The heat transfer fluid 16 then flows through one of the central wells 26 or the flank well 28.

The heat transfer fluid 16 is then distributed in the drains 30 where, thanks to the non-adiabatic walls of the linear portions 54 of the drains 30, the fluid 16 receives a heat flow from the hot rocks present in the subsoil 22.

Nozzles or flow restrictors are advantageously installed in the drains 30 to adjust the flow distribution in said drains.

The heat transfer fluid 16 is then returned to the recovery system 18 via the other of the central well 26 or the flank well 28 and exits via its wellhead 32 or 34. Advantageously, after filtering, it then passes into the energy distribution and/or conversion device 20 where it transmits its thermal energy so that it can be distributed to a heating system (housing, factory, industrial process, greenhouses, hotel, swimming pool, recreation centre, etc.) and/or converted into mechanical energy and possibly electrical energy by a generator, etc.) and/or converted into mechanical energy and possibly electrical energy by a generator.

The heat transfer fluid 16 is then redirected, if necessary, to a condenser for regeneration or cooling. It is then reinjected into the drilling layout 12 by the pumping system 14 and the cycle starts again.

The drilling layout 12 in accordance with the invention is simple to drill thanks to simplified trajectories, while allowing efficient heat exchange between the heat transfer fluid 16 and the subsoil 22. Drilling in the same vertical plane limits angular deviations, which are a source of risk and cost. In addition, the drilling of such a layout 12 is facilitated by a drilling tool 64 having a rotary swivel system 65, such as that illustrated in WO 2007/110502.

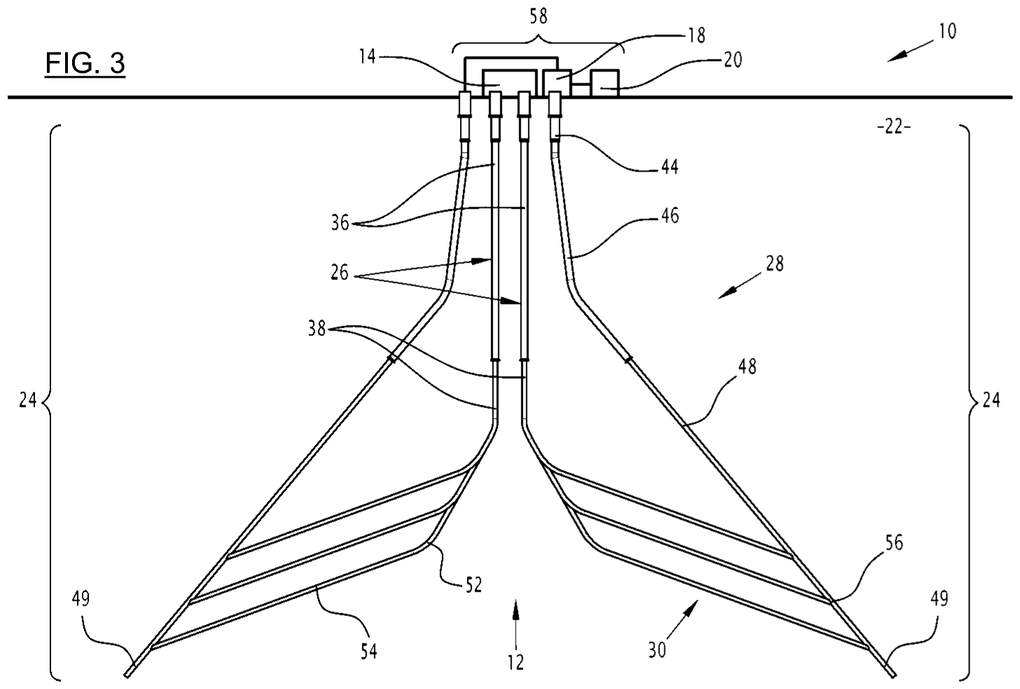

In another embodiment, a plurality of heat exchange units 24 are drilled side by side. As shown in FIG. 3, two heat exchange units 24 are represented in the same plane and share the same surface assembly 58. Alternatively, the “N” heat exchange units 24, each located in a plane, are not coplanar with each other. They are then distributed either linearly in parallel exchanger planes, or around a vertical axis every 360/N°.

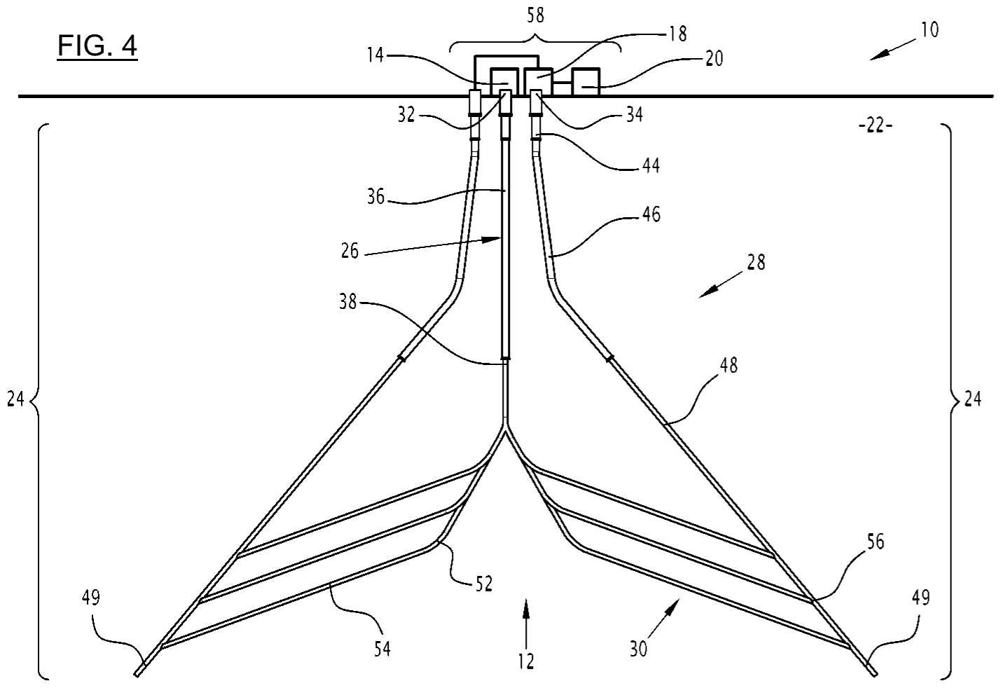

These two heat exchange units 24 are also shown in another configuration with a central well 26 common to both units 24 as shown in FIG. 4. Alternatively, “N” heat exchange units 24 are distributed uniformly around the axis of the central well 26 common to the “N” units 24.

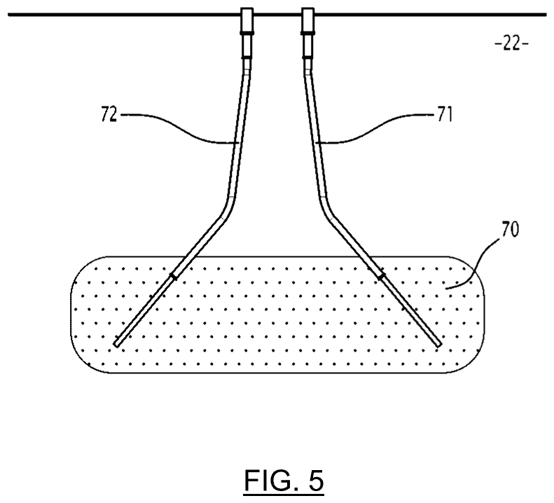

A variant of the drilling method is shown in FIG. 5. In such a method, a drilling layout designed to exploit geothermal fluid contained in an aquifer 70 is initially drilled. This layout comprises several lateral drilled wells 71, 72 normally designed to recover and/or exploit the geothermal fluid.

If the production of geothermal fluid is not possible or is not sufficient for the exploitation of the aquifer 70 to be profitable, at least one central well 26 is drilled in the plane of each flank well 71, 72, then drains 30 are drilled through the aquifer 70. The geothermal fluid used is then replaced by a heat transfer fluid 16 after installing a suitable surface assembly 58.

This drilling method makes it possible to amortise the costs of drilling lateral wells 71, 72, when the exploitation of the aquifer 70 is no longer desired or feasible.

In this application, “geothermal energy” refers to all the techniques used to exploit the internal thermal phenomena of the earth by heat exchange with the subsoil. The geothermal installation 10 can therefore be used as described above to heat the heat transfer fluid 16 by spontaneous transfer of thermal energy from the hot subsoil 22 to the heat transfer fluid 16 which is colder than the subsoil. Alternatively, the geothermal installation 10 can be used to cool a heat transfer fluid 16 that is warmer than the subsoil 22 by spontaneous heat transfer from a heat transfer fluid 16 to the colder subsoil 22. In general, this does not require any modification to the drilling layout 12, just an adaptation of the energy distribution and/or conversion device 20 on the surface.

In one embodiment of the geothermal installation 10, as indicated above, the surface distance between the central well 26 and the flank well 28 within the same heat exchange unit is between 20 m and 100 m. The central and lateral wells are therefore close together. Consequently, only one drilling site is required for the entire geothermal installation 10.

In the examples shown in the figures, the central well 26 and the or each flank well 28 are asymmetrical, i.e. there is no vertical plane of symmetry between the central well 26 and the or each flank well other than that in which the central well 26, the flank well 28 and the drains 30 are arranged

The drilling of the inclined lateral portion 48 of the flank well 28 and the linear portions 54 of the drains 30 (referred to as “slants”) of the drilling layout 12 can be carried out by means of a drilling device comprising a rotary drilling assembly (referred to as a “rotary bottom hole assembly” or by the acronym “rotary BHA”). This limits drilling costs.

1. A drilling layout provided in a subsoil for a geothermal installation, comprising a heat exchange unit comprising:
a central well extending from a surface of the subsoil;
a flank well extending from the surface of the subsoil and comprising an inclined lateral portion; and
at least two separate drains connecting said central well and said inclined lateral portion of said flank well, wherein said central well, said flank well and each of said drains are set out in one same vertical plane, a central intersection between said drains and said central well and a lateral intersection between said drains and said inclined lateral portion being separated from one another and said drains opening inclined by an angle less than 45° with respect to said inclined lateral portion.

2. The drilling layout according to claim 1, wherein said central well is vertical.

3. The drilling layout according to claim 1, wherein said central well comprises an upper vertical portion located above said drains, said upper vertical portion having a diameter greater than a diameter of each of said drains.

4. The drilling layout according to claim 1, wherein said drains are drilled in a plutonic rock or in a metamorphic rock.

5. The drilling layout according to claim 1, wherein said heat exchange unit comprises at least one sedimentation leg terminating at least one of said central well and said inclined lateral portion.

6. The drilling layout according to claim 1, wherein an angle formed by the local axis of said central well, oriented downwards at the central intersection, and the local axis of said drain, taken at the lateral intersection, oriented away from said central well, is strictly less than 90°.

7. The drilling layout according to claim 1, wherein each of said drains comprises a linear portion vertically spaced apart by a maximum of 200 meters, said linear portions being parallel to one another.

8. The drilling layout according to claim 1, wherein a surface distance between said central well and said flank well is between 20 m and 100 m.

9. A geothermal installation comprising:
a drilling layout according to claim 1;
a system for pumping heat-transfer fluid to be heated into either the central well of said drilling layout or the flank well of said drilling layout;
a system for recovering heat-transfer fluid heated from the other of the central well and the flank well; and
a device for distributing and/or converting energy from the heated heat transfer fluid.

10. A method for manufacturing a drilling layout in a subsoil comprising:
drilling a flank well comprising an inclined lateral portion from a surface of the subsoil;
drilling a central well from the subsoil surface;
drilling at least two separate drains connecting the central well and the inclined lateral portion of the flank well,
wherein the central well, the flank well and each drain are drilled in one same vertical plane, a central intersection between the drains and the central well and a lateral intersection between the drains and the inclined lateral portion are separated from one another and the drains opening inclined by an angle less than 45° with respect to the inclined lateral portion.

11. The method according to claim 10, wherein said drilling the flank well comprises:
injecting drilling fluid through a drilling tool;
returning the drilling fluid through the flank well in an annulus defined between the drilling tool and a wall of the flank well, said drilling of the central well from the surface and of at least a first drain being carried out after said drilling of the flank well; and
keeping the drilling fluid under pressure in the flank well at least during formation of the lateral intersection between the first drain and the inclined lateral portion, the drilling fluid under pressure in the inclined lateral portion rising through the first drain towards the central well after the lateral intersection is formed.

12. The method according to claim 11, wherein said drilling of at least two separate drains comprises comprises:
drilling a second drain above the first drain; and
after the drilling of the first drain, keeping pressurized drilling fluid in circulation in the flank well and through the first drain at least while the lateral intersection between the second drain and the inclined lateral portion is formed, the pressurized drilling fluid in the inclined lateral portion rising through the second drain towards the central well after the lateral intersection is formed.

13. The drilling layout according to according to claim 1, wherein said drains are drilled in granite.

14. The drilling layout according to according to claim 1, wherein said drains are drilled in gneiss.

15. The drilling layout claim 1, wherein an angle formed by the local axis of said central well, oriented downwards at the central intersection, and the local axis of said drain, taken at the lateral intersection, oriented away from said central well, is between 45° and 70°.
